(19) United States
(12) Patent Application Publication
(10) Pub. No.: US 2005/0207660 A1
(43) Pub. Date: Sep. 22, 2005

(54) System and method for reduction of compressed image artifacts

(75) Inventor: Albert D. Edgar, Austin, TX (US)

Correspondence Address: FORTKORT GRETHER + KELTON LLP, 8911 N. CAPITAL OF TEXAS HWY., SUITE 3200, AUSTIN, TX, 78759, US

(73) Assignee: SozoTek, Inc.

(21) Appl. No.: 11/079,036

(22) Filed: Mar. 12, 2005

Related U.S. Application Data
(60) Provisional application No. 60/553,331, filed on Mar. 16, 2004.

(51) Int. Cl. G06K 9/36

(52) U.S. Cl. 382/232

(57) ABSTRACT

Provided is a system and method for processing images. A method for removing artifacts for restoring a block of data includes but is not limited to receiving one or more original transform coefficients of the block of data; quantizing the original transform coefficients of the block of data, the quantizing resulting in one or more quantization levels associated with the one or more original transform coefficients; applying an artifact reduction process to the quantized original transform coefficients; adjusting one or more quantized data values representing the transform coefficients as altered by the artifact reduction process if any of the one or more quantized data values are outside the one or more quantization levels after applying the artifact reduction process; and reapplying the artifact reduction process and readjusting the adjusted quantized data values, the reapplying the artifact reduction process enabling restoration of the block of data.

### CROSS-REFERENCE TO RELATED APPLICATION

This application claims priority to U.S. Provisional Ser. No. 60/553331, filed Mar. 16, 2004, having the same inventor, and is incorporated herein by reference in its entirety.

### TECHNICAL FIELD

The present application relates generally to the field of processing block data, and, more particularly to removal of artifacts from compressed block data, such as images.

### SUMMARY

In one aspect, a method is directed to removing artifacts for restoring one or more data blocks. The data blocks can be image data, sound data, or other data appropriate for manipulation into discrete cosine transform coefficients, discrete Fourier transform coefficients, wavelet transform coefficients, fractal transform coefficients and the like. One method includes but is not limited to receiving one or more quantized transform coefficients of the one or more data blocks quantized according to a quantization table, the quantization table identifying two or more quantization levels; reducing one or more artifacts via an artifact reduction process from the quantized transform coefficients, the artifact reduction process resulting in one or more processed transform coefficients; and redistributing the processed transform coefficients in a transform domain to provide that the processed transform coefficients relate to the quantization table. The redistributing the processed transform coefficients to provide that the processed transform coefficients relate to the quantization table can include maintaining a relative magnitude with respect to the order of the quantized transform coefficients; and insuring the processed transform coefficients are located in the same two or more quantization levels as quantized according to the quantization table. The method can further include redistributing the rearranged processed transform coefficients across the quantization levels according to one or more predetermined criteria; and/or repeating the applying the artifact reduction process and the reducing until a distribution of the rearranged processed transform coefficients across the quantization levels one or more predetermined criteria. The method can further include, but not be limited to, determining an entropy for the one or more data blocks prior to reducing the artifacts via the artifact reduction process; comparing a first entropy of the one or more data blocks prior to reducing the artifacts via the artifact reduction process with a second entropy of the one or more data blocks after the rearranging the one or more processed transform coefficients; and if the second entropy is lower than the first entropy, increasing the second entropy as a function of one or more of a probability distribution function, a uniform distribution function, a scalar value and/or a most likely (ML) algorithm.

The predetermined criteria can include one or more of a uniform distribution, a distribution altered by a scalar, and/or a distribution matching a predicted probability distribution function of the one or more data blocks.

In one embodiment, the processing the reduced artifact quantized transform coefficients can include, but is not limited to determining a probability distribution function of a quantization level for each processed quantized transform coefficient; and altering the magnitude of one or more of the processed quantized transform coefficients according to the probability distribution function for the quantization level.

In another aspect a method for removing artifacts for restoring a block of data includes but is not limited to receiving one or more original transform coefficients of the block of data; quantizing the original transform coefficients of the block of data, the quantizing resulting in one or more quantization levels associated with the one or more original transform coefficients; applying an artifact reduction process to the quantized original transform coefficients; adjusting one or more quantized data values representing the transform coefficients as altered by the artifact reduction process if any of the one or more quantized data values are outside the one or more quantization levels after applying the artifact reduction process; and reapplying the artifact reduction process and readjusting the adjusted quantized data values, the reapplying the artifact reduction process enabling restoration of the block of data.

The method can further include optimizing each of the adjusted quantized data values as a function of one or more adjusted quantization values in an associated quantization level according to a measurement of error, such as a mean squared error and/or a measurement of the quantization level entropy as compared to an estimate of entropy of a source of the block of data.

In one embodiment, the adjusting one or more quantized data values representing the transform coefficients as altered by the artifact reduction process if any of the one or more quantized data values are outside the one or more quantization levels after applying the artifact reduction process can include determining a transform coefficient associated with one or more of the quantized data values; determining a quantization level associated with the transform coefficient; and, if the quantized data values fall outside the quantization level associated with transform coefficient, adjusting the quantized data values to within the quantization level associated with the transform coefficient. The reapplying the artifact reduction process enabling restoration of the block of data can include converging on optimal quantized data values that converge on a probability distribution function associated with a source of the block of data.

In another aspect, a method for restoring image data includes, but is not limited to receiving a compressed image; decompressing the compressed image, the decompressing including applying a quantization table; filtering the decompressed image; applying a limiting process to one or more coefficients of the filtered decompressed image, the limiting process altering the one or more coefficients to match the quantization table to enable construction of an altered reconstructed image; and comparing the altered reconstructed image with the decompressed image to monitor a loop control process.

The loop control process can include, but not be limited to the limiting process, and the filtering and an optimization process, the optimization process altering the altered one or more coefficients to within a predetermined statistical range.

In one aspect, a system includes, but is not limited to a processor; a memory coupled to the processor; and an image processing module coupled to the memory, the image processing module including a decompressor configured to receive a compressed image and decompress the compressed image with a quantization table; a filter coupled to the decompressor, the filter configured to remove artifacts from the decompressed image via a smoothing function; a limiter coupled to the filter, the limiter processing the one or more coefficients of the filtered decompressed image, the limiter altering the one or more coefficients to match the quantization table; and a control loop coupled to the limiter, the control loop configured to alter one or more components of the reconstructed image with the decompressed image to monitor a loop control process.

In one aspect, a computer program product includes a computer readable medium configured to perform one or more acts for receiving one or more original transform coefficients of the block of data; quantizing the original transform coefficients of the block of data, the quantizing resulting in one or more quantization levels associated with the one or more original transform coefficients; applying an artifact reduction process to the quantized original transform coefficients; adjusting one or more quantized data values representing the transform coefficients as altered by the artifact reduction process if any of the one or more quantized data values are outside the one or more quantization levels after applying the artifact reduction process; and reapplying the artifact reduction process and readjusting the adjusted quantized data values, the reapplying the artifact reduction process enabling restoration of the block of data.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

A better understanding of the subject matter of the present application can be obtained when the following detailed description of the disclosed embodiments is considered in conjunction with the following drawings, in which:

FIG. 1 is a block diagram of an exemplary computer architecture that supports the claimed subject matter;

FIG. 2 is a block diagram illustrating an embodiment of the present invention.

FIG. 3 is a flow diagram illustrating a method in accordance with an embodiment of the present application.

FIG. 4 is a flow diagram illustrating a method in accordance with an embodiment of the present application.

FIG. 5 is a flow diagram illustrating a method in accordance with an embodiment of the present application.

### DETAILED DESCRIPTION OF THE DRAWINGS

Those with skill in the computing arts will recognize that the disclosed embodiments have relevance to a wide variety of applications and architectures in addition to those described below. In addition, the functionality of the subject matter of the present application can be implemented in software, hardware, or a combination of software and hardware. The hardware portion can be implemented using specialized logic; the software portion can be stored in a memory or recording medium and executed by a suitable instruction execution system such as a microprocessor.

More particularly, the embodiments herein include methods related to decompressing image data that have been compressed with a block transform based “lossy” compression process. Examples of “lossy” compression include JPEG or MPEG. “Lossy” image compression methods such as JPEG result in reconstructed images that have “artifacts” that degrade the clarity of the image. The present application discloses methods to decompress compressed image files and reconstruct an image that represents, as near as possible, the original image with fewer artifacts. The methods described herein can be used with a decompression process, sometimes referred to as a decoder. The compression process can be an unaltered compression process and can include a block transform compression such as a JPEG standard process. Further, methods described herein can operate using only data available by the compressed image file itself independent of additional information about the source subject or the compressor.

Image compression methods such as JPEG are termed “Lossy” as reference to the fact that image information is mathematically discarded or reduced. JPEG compression process divides the image into sub-blocks of 8 by 8 blocks pixels. Each 8×8 image sub-block is transformed using the Discrete Cosine Transform (DCT) into the frequency domain. The DCT coefficients are then quantized into discrete levels. The final stages of the JPEG standard include encoding the quantized DCT coefficients using “Run Length Encoding” and “Huffman Encoding” to produce the final compressed image file.

Reconstructed images can include “artifacts” due to losses created by the quantization process. These artifacts degrade the visual clarity of the image. Artifacts appear as blocks, ripples, noise and checkered patterns. More artifacts are produced with higher compression ratios. Block artifacts are vertical and horizontal borders that appear in the reconstructed image around the 8×8 block edges used in the JPEG algorithm. Block artifacts also manifest as grid-type lines, staircase lines and corner outliers. Corner outliers are areas of change in contrast at a corner area of a block. Artifacts may also appear as noise shaped as small pixel-sized rectangles or ripples occurring near an edge or high contract boundary.

Another effect of the compression is loss of color information. The human eye is not sensitive to color changes. Compression techniques such as JPEG reduce the color information to a greater extent as compared to luminance information. The loss of color information produces lower color detail and sharpness, and may create color “blotch” artifacts.

Prior methods to reduce JPEG artifacts using techniques such as locating the artifacts and using a filter to “smooth” or “blur” the region near the artifact. These techniques result in a blurred quality that lacks the clarity of the original image. In general, methods that use filtering, regardless of complexity, alter the image such that the reconstructed image deviates from original image. Other prior compression methods involve replacement of both the compressor (encoder) and decompressor (decoder). These methods would necessitate changes to encoding devices such as digital cameras, camera phones, scanners, and the like. that are already deployed in the market in large quantities. The methods disclosed herein require no changes to the encoding devices, the transmission system or the storage media to produce superior results.

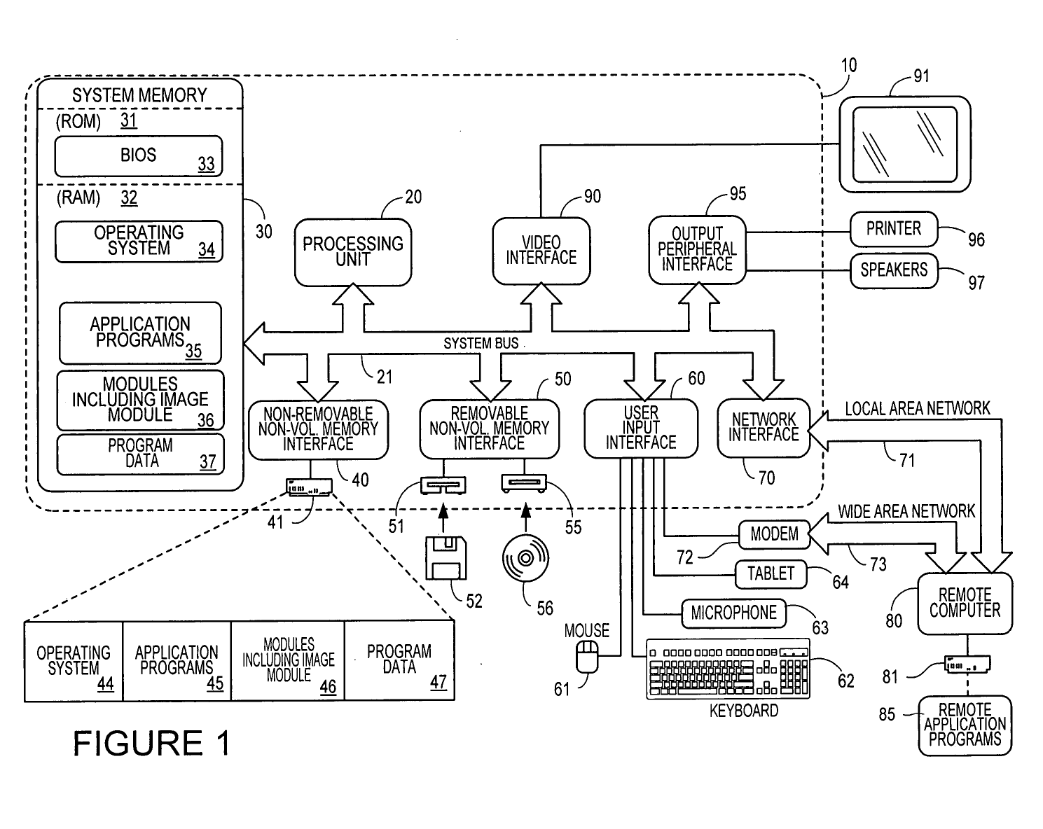

With reference to FIG. 1, an exemplary computing system for implementing the embodiments and includes a general purpose computing device in the form of a computer 10. Components of the computer 10 may include, but are not limited to, a processing unit 20, a system memory 30, and a system bus 21 that couples various system components including the system memory to the processing unit 20. The system bus 21 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 10 typically includes a variety of computer readable media. Computer readable media can be any available media that can be accessed by the computer 10 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 10. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 30 includes computer storage media in the form of volatile and/or nonvolatile memory such as read only memory (ROM) 31 and random access memory (RAM) 32. A basic input/output system 33 (BIOS), containing the basic routines that help to transfer information between elements within computer 10, such as during start-up, is typically stored in ROM 31. RAM 32 typically contains data and/or program modules that are immediately accessible to and/or presently being operated on by processing unit 20. By way of example, and not limitation, FIG. 1 illustrates operating system 34, application programs 35, other program modules 36 and program data 37. FIG. 1 is shown with program modules 36 including an image processing module in accordance with an embodiment as described herein.

The computer 10 may also include other removable/non-removable, volatile/nonvolatile computer storage media. By way of example only, FIG. 1 illustrates a hard disk drive 41 that reads from or writes to non-removable, nonvolatile magnetic media, a magnetic disk drive 51 that reads from or writes to a removable, nonvolatile magnetic disk 52, and an optical disk drive 55 that reads from or writes to a removable, nonvolatile optical disk 56 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 41 is typically connected to the system bus 21 through a non-removable memory interface such as interface 40, and magnetic disk drive 51 and optical disk drive 55 are typically connected to the system bus 21 by a removable memory interface, such as interface 50. An interface for purposes of this disclosure can mean a location on a device for inserting a drive such as hard disk drive 41 in a secured fashion, or a in a more unsecured fashion, such as interface 50. In either case, an interface includes a location for electronically attaching additional parts to the computer 10.

The drives and their associated computer storage media, discussed above and illustrated in FIG. 1, provide storage of computer readable instructions, data structures, program modules and other data for the computer 10. In FIG. 1, for example, hard disk drive 41 is illustrated as storing operating system 44, application programs 45, other program modules, including image processing module 46 and program data 47. Program modules 46 is shown including an image processing module, which can be configured as either located in modules 36 or 46, or both locations, as one with skill in the art will appreciate. More specifically, image processing modules 36 and 46 could be in non-volatile memory in some embodiments wherein such an image processing module runs automatically in an environment, such as in a cellular phone. In other embodiments, image processing modules could be part of a personal system on a hand-held device such as a personal digital assistant (PDA) and exist only in RAM-type memory. Note that these components can either be the same as or different from operating system 34, application programs 35, other program modules, including queuing module 36, and program data 37. Operating system 44, application programs 45, other program modules, including image processing module 46, and program data 47 are given different numbers hereto illustrate that, at a minimum, they are different copies. A user may enter commands and information into the computer 10 through input devices such as a tablet, or electronic digitizer, 64, a microphone 63, a keyboard 62 and pointing device 61, commonly referred to as a mouse, trackball or touch pad. Other input devices (not shown) may include a joystick, game pad, satellite dish, scanner, or the like. These and other input devices are often connected to the processing unit 20 through a user input interface 60 that is coupled to the system bus, but may be connected by other interface and bus structures, such as a parallel port, game port or a universal serial bus (USB). A monitor 91 or other type of display device is also connected to the system bus 21 via an interface, such as a video interface 90. The monitor 91 may also be integrated with a touch-screen panel or the like. Note that the monitor and/or touch screen panel can be physically coupled to a housing in which the computing device 10 is incorporated, such as in a tablet-type personal computer. In addition, computers such as the computing device 10 may also include other peripheral output devices such as speakers 97 and printer 96, which may be connected through an output peripheral interface 95 or the like.

The computer 10 may operate in a networked environment using logical connections to one or more remote computers, which could be other cell phones with a processor or other computers, such as a remote computer 80. The remote computer 80 may be a personal computer, a server, a router, a network PC, PDA, cell phone, a peer device or other common network node, and typically includes many or all of the elements described above relative to the computer 10, although only a memory storage device 81 has been illustrated in FIG. 1. The logical connections depicted in FIG. 1 include a local area network (LAN) 71 and a wide area network (WAN) 73, but may also include other networks. Such networking environments are commonplace in offices, enterprise-wide computer networks, intranets and the Internet. For example, in the subject matter of the present application, the computer system 10 may comprise the source machine from which data is being migrated, and the remote computer 80 may comprise the destination machine. Note however that source and destination machines need not be connected by a network or any other means, but instead, data may be migrated via any media capable of being written by the source platform and read by the destination platform or platforms.

When used in a LAN or WLAN networking environment, the computer 10 is connected to the LAN through a network interface or adapter 70. When used in a WAN networking environment, the computer 10 typically includes a modem 72 or other means for establishing communications over the WAN 73, such as the Internet. The modem 72, which may be internal or external, may be connected to the system bus 21 via the user input interface 60 or other appropriate mechanism. In a networked environment, program modules depicted relative to the computer 10, or portions thereof, may be stored in the remote memory storage device. By way of example, and not limitation, FIG. 1 illustrates remote application programs 85 as residing on memory device 81. It will be appreciated that the network connections shown are exemplary and other means of establishing a communications link between the computers may be used.

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those of skill in the art will appreciate that some of the acts and operation described hereinafter can also be implemented in hardware.

FIG. 1 illustrates program modules 36 and 46 can be configured to include a computer program for receiving a compressed image file as input and produce a processed compressed image file as output. The processed output image according to an embodiment can have significant reduction of visual artifacts, with little degradation of image clarity and other visual qualities.

As described above, the compressed image data contains no additional information about the composition of the original image. The compressed image file does however provide information used to compress the original image. The file contains the quantization table used, the image resolution (X by Y), the image color space and the color sub sampling details.

The present application, and in particular the methods and systems disclosed herein uses “a priori” knowledge concerning images and mathematics. The majority of natural images contain mostly relatively smooth areas with small changes and occasional edges or large changes. The probability distribution function (PDF) of the first derivative across a typical image appears as a strong peak in the center with long tails to either side and can be well modeled by a Laplacian PDF. Noise, and like artifacts are typically modeled as a Gaussian probability distribution. An image containing blocking artifacts presents as PDF that is mostly Laplacian in distribution with a Gaussian function superimposed.

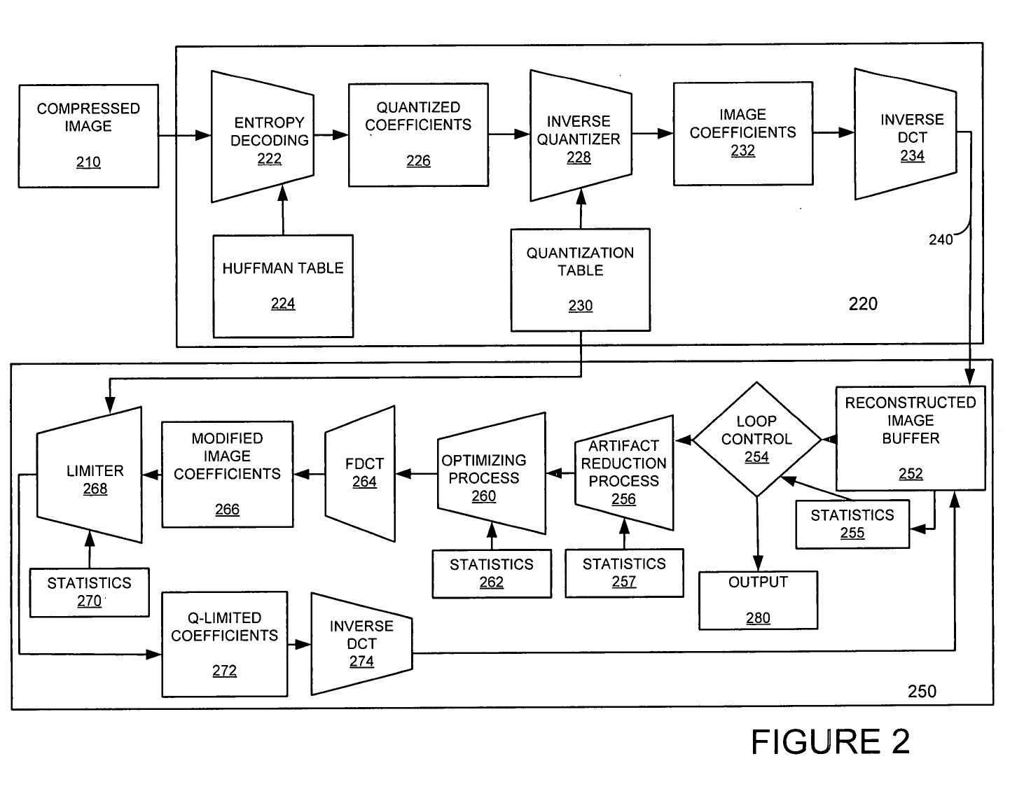

Referring to FIG. 2, a block diagram refers to images after JPEG compression process, including a decompressor 220 and an iterative artifact reduction process 250. Each of the processes 220 and 250 can use high precision floating point numbers.

Generally, the process of JPEG is to divide the image into sub-blocks of 8 by 8 blocks pixels. Each 8×8 image sub-block is processed using the Discrete Cosine Transform (DCT) to transform the image into the frequency domain. The DCT coefficients are then quantized into discrete quantization levels. The final stages of the JPEG standard are to encode the quantized DCT coefficients using “Run Length Encoding” and “Huffman Encoding” to produce the final compressed image file. Given the nature of the quantization, the quantized DCT coefficients will assume a normal probability distribution within the quantization bin. The original DCT coefficients will have an equal probability to exist anywhere between the limits of each quantization level.

FIG. 2 illustrates a process for reducing compressed image artifacts that can be configured as an application module 36 and/or 46 in FIG. 1. Block 210 can be a compressed image, such as a JPEG or MPEG type file. The compressed image enters decompressor 220, which can be configured as a JPEG decompressor. Within decompressor 220, the data is received by entropy decoding block 222, which receives Huffman decoding data from Huffman table 224 and extracts the quantized coefficients which does an Huffman decoding on the run lengths from the compressed image. The decoded data then passes to quantized coefficients block 226. The quantized coefficients enter an inverse quantizer 228, which receives data from quantization table 230 and in conjunction with the quantized coefficients, extracts the DCT coefficients. The data output from inverse quantizer 228 is then provided to image coefficient block 232. The image coefficients are operated on to determine an inverse DCT at block 234. The output is a reconstructed image 240 according to a standard decompressor for block transform methods.

According to an embodiment, decompressor 220 interacts with an artifact reduction control process 250 to produce an output file that includes a reconstructed image after artifact removal.

More particularly, reconstructed image 240 is received by reconstructed image buffer 252. Image buffer 252 holds reconstructed images and updates the reconstructed images in accordance with the iterative process 250 for each iteration through a control process. The image data is subject to a loop control 254 which monitors and adjusts the processing parameters for optimal loop stability and convergence. The loop control process 254 receives statistics to assess visual improvement of the image data, which can include, but is not limited to such measures as perceived signal to noise ratio (PSNR), mean squared error (MSE) and/or the gradient of the probability distribution function (PDF).

The image data is passed to artifact reduction process 256 which can include a process configured to alter the PDF statistics of the overall image data from a Gaussian PDF profile including signal plus noise and artifacts, toward a Laplacian PDF profile, or a PDF profile of the original image, if known. The artifact reduction process can include a simple algorithm such as that introduced by J. Chou, M. Crouse, and K. Ramchandran, “A simple algorithm for removing artifacts in block-transform coded images,” IEEE Signal Proc. letters, vol. 5, pp. 33-35, February 1998.

In one embodiment, the artifact reduction process 256 estimates the noise, and removes artifact candidate data identified by being below a predetermined magnitude of error. For example, the artifact reduction process can take into account an amount of lines on block edges and within blocks. Thus, artifact reduction process 256 can estimate the error or step size for the edge of a block from the quantization table of the original data so that if the original data is finely quantized, a small error is present. Conversely, a coarse quantization results in a larger error. Based on the magnitude of the expected error at lower frequencies, edge artifacts are removed only up to the value of the expected quantization error associated with the coarseness. Thus, in one embodiment, artifact reduction process 256 determines the quantization type prior to adjusting the edge boundaries. The finer the quantization, the more the edge boundaries can be adjusted. The limits on the magnitudes for edge adjustment are thus a function of the quality of the quantization.

As one of skill in the art will appreciate, the data concerning the quantization levels and associated error is best determined using the original quantization data. If the type of quantization is unknown, the coarseness and frequency of the quantization can determined by looking at the lower frequency data and making a determination according to the quantum size of the data at lower frequencies. Thus, the quantization error can be determined using post processing techniques by examining lower frequency data blocks and determining error measurement therein; and conversely higher frequency data blocks and determining an error measurement.

For artifact removal within the blocks of data, checkerboard patterns resulting from high frequency JPEG basis functions can be removed. More specifically, a threshold magnitude for removal of artifacts within each block is determined by first determining a magnitude of quantization error at the higher frequencies.

As a result of the processes, data removed causes removal of energy from the image data. Although the energy of the image is reduced after the artifact removal process, the original energy of the image is known. According to an embodiment, iterative process 250 can ensure that the original energy of the image is preserved, as explained below.

The iterative artifact reduction process 250 can adjusted the artifact reduction process 256 with each iteration of the control loop to converge on an optimal image. In one embodiment, the artifact reduction process 256 includes filtering for the center region of a block using a bias based on a quantization table frequency response.

In another embodiment, the artifact reduction process 256 can include a method for operating on the region of the block boundaries according to local activity in the image. If the discontinuity at a block boundary is small compared to the local energy in the image, it can be determined that it is likely that a discontinuity is due to quantization. Thus, a strong filtering operation can be performed. Very large discontinuities at block boundaries are less likely to be due to quantization error. Accordingly, the process applies a milder smoothing operation to preserve image edges.

After artifact reduction process 256, an optimizer process 260 can take place. The optimizer process can be configured to methodically adjust each DCT coefficient to a value, which, in combination with the other coefficients in the block, approach a target statistic provided by statistic block 262. The target statistic can be a measurement of error, such as Mean Squared Error (MSE), and/or a measurement of the block's entropy relative to an estimation of the entropy of the original image as calculated by the previous artifact reduction filter process. In one embodiment, the optimizer process uses high precision floating point numbers.

After optimizer process 260, the image data is transformed by forward discrete cosine transform (FDCT) process 264 to produce modified image coefficients (block 266) in the transform domain.

The resulting DCT coefficients are adjusted by a limiter function shown in limiter 268 to alter the coefficients to be within quantification level limits as defined by the original quantification tables 230 to be within the bounds of the original quantization coefficient level one at a time. More specifically, the DCT coefficients resulting from the artifact reduction process 256 are likely adjusted from the center point of the quantization levels defined by the original quantization tables 230. In fact, depending on the artifact reduction process used, some coefficients can be in levels not specified by the original quantization levels. Specifically, limiter 268 can create new values that are a closer approximation of the actual value of the original DCT coefficients prior to quantization. Thus, if the improved image reconstruction was recompressed with the same quantization table, the resulting compressed image file would be identical to the original compressed image file.

Limiter 268 receives statistics information from statistics 270. More specifically, statistics 270 can be configured to provide statistics such as the probability distribution function of coefficient levels, and/or the probability distribution function of the original image, a statistically likely PDF of the original image, or the like. In one embodiment, limiter 268 can include a most likely type algorithm to place coefficients in quantization levels or within quantization levels in accordance with probabilities that are determined as a function of the location of the quantization level.

In one embodiment limiter 268 takes into account the energy in the data and insures that the total energy, or entropy, of the image is conserved. If the energy is less than the original energy of the data due to artifact reduction process 256, limiter 268 can proportionally replace the energy across the coefficients. Alternatively, limiter 268 can replace the energy across the coefficients according to a most likely algorithm, a probability distribution function or the like. The conservation of the data energy can occur at the limiter 268 or at another post process 256 location in accordance with system requirements.

The altered coefficients, shown in Q-limited coefficient block 272 are then provided to inverse discrete cosine transform (IDCT) block 274 to produce reconstructed image data, which is fed back to image buffer 252, wherein the iteration is compared against prior iterations to insure that an improvement of the artifact reduction process was successful. Image buffer 252 and loop control monitor and adjust the processing parameters until a final image reconstruction is determined. The criteria for determining a final image reconstruction can be determined according to predetermined criteria for image improvement. After predetermined criteria are met, the loop process terminates the iteration cycle and produces an output image file 280. File 280 can include an uncompressed reconstruction of the image or a recompressed reconstruction of the image as one of skill in the art with the benefit of this disclosure will appreciate. The type of output file 280 can depend on the type of destination for file 280.

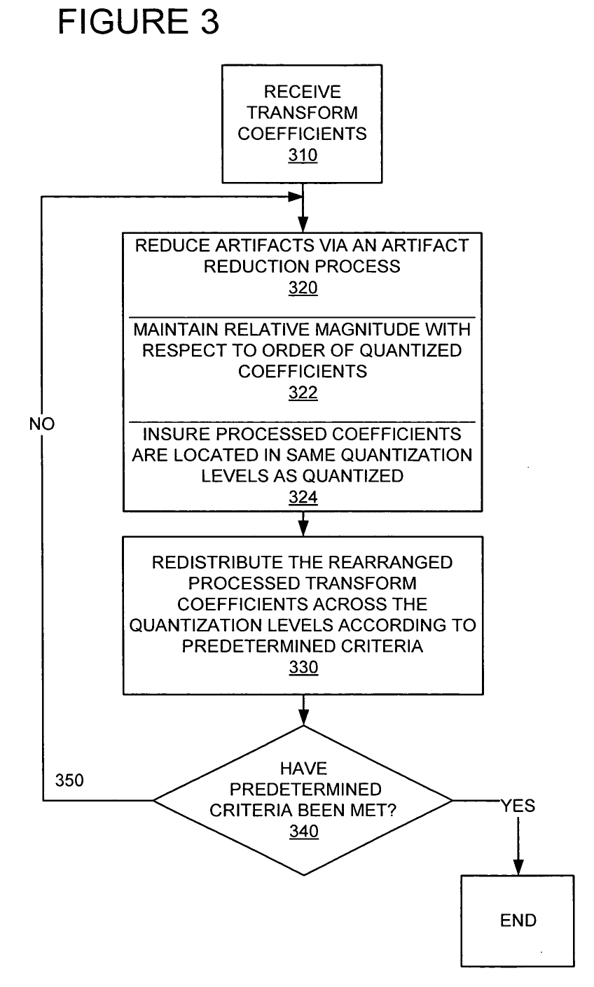

Referring now to FIG. 3, a flow diagram illustrates a method in accordance with an embodiment for removing artifacts for restoring a block of data. Block 310 provides for receiving one or more quantized transform coefficients of one or more data blocks quantized according to a quantization table. The quantization table can be configured to identify two or more quantization levels. Block 320 provides for reducing one or more artifacts via an artifact reduction process from the quantized transform coefficients. The artifact reduction process can result in one or more processed transform coefficients. In one embodiment, the artifact reduction process can include a smoothing operation or another type of process. In one embodiment, the artifact reduction process includes determining a probability distribution function of a quantization level for each processed quantized transform coefficient and altering the magnitude of one or more of the processed quantized transform coefficients according to the probability distribution function for the quantization level. In another embodiment, the artifact reduction process can be a simple removal process as one of skill in the art will appreciate, such as the simple algorithm by J. Chou, M. Crouse, and K. Ramchandran described above.

Redistributing the processed transform coefficients in a transform domain to provide that the processed transform coefficients relate to the quantization table. More particularly, the relating to the quantization table according to an embodiment includes, as shown in block 322 maintaining a relative magnitude with respect to the order of the quantized transform coefficients, and, in block 324, insuring the processed transform coefficients are located in the same two or more quantization levels as quantized according to the quantization table.

Block 330 provides for redistributing the rearranged processed transform coefficients across the quantization levels according to one or more predetermined criteria.

In one embodiment, the redistributing can be performed iteratively, as shown in decision block 340. If iterative, block 350 provides for repeating the applying the artifact reduction process and the reducing until a distribution of the rearranged processed transform coefficients across the quantization levels one or more predetermined criteria. The predetermined criteria can include one or more of a uniform distribution, a distribution altered by a scalar, and/or a distribution matching a predicted probability distribution function of the one or more data blocks. The predicted probability distribution function (PDF) of the one or more data blocks can be of either the PDF of the quantization level or of the entire set of data blocks. If an image, the predicted PDF can relate to the entire image.

In one embodiment, the method can include comparing a first entropy of the one or more data blocks prior to reducing the artifacts via the artifact reduction process with a second entropy of the one or more data blocks after the rearranging the one or more processed transform coefficients. If the second entropy is lower than the first entropy, the method can include increasing the second entropy as a function of one or more of a probability distribution function, a uniform distribution function, a scalar value and/or a most likely (ML) algorithm. Thus, the entropy of the original data blocks is maintained throughout the process. If the data represents an image, the method maintains the energy f the image throughout the process.

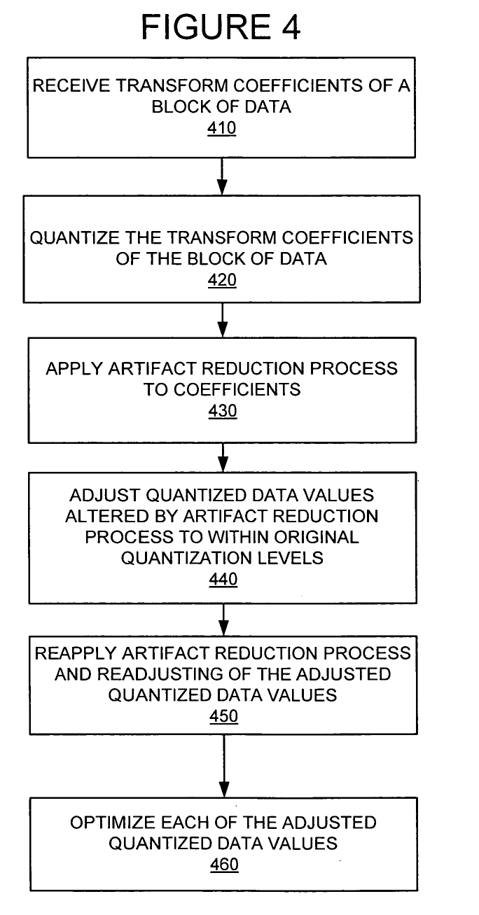

Referring now to FIG. 4, a flow diagram illustrates another method in accordance with an embodiment for artifact removal.

Block 410 provides for receiving one or more original transform coefficients of a block of data. The original transform coefficients can include coefficients from different types of transforms including DCT, DFT, wavelet, fractal and the like.

Block 420 provides for quantizing the original transform coefficients of the block of data. The quantizing results in one or more quantization levels associated with the one or more original transform coefficients. Quantization can be performed by a uniform quantizer or other appropriate quantization process as will be appreciated by those of skill in the art.

Block 430 provides for applying an artifact reduction process to the quantized original transform coefficients. The artifact reduction process can be a simple process or another process or algorithm as one of skill in the art will appreciate, such as the simple algorithm by J. Chou, M. Crouse, and K. Ramchandran described above.

Block 440 provides for adjusting one or more quantized data values representing the transform coefficients as altered by the artifact reduction process. More particularly, if any of the one or more quantized data values are outside the one or more quantization levels after applying the artifact reduction process, block 340 provides for adjusting the quantized data values to values within the original quantization levels.

In one embodiment, the adjusting one or more quantized data values representing the transform coefficients as altered by the artifact reduction process includes determining a quantization level associated with the transform coefficient. If the quantized data values fall outside the quantization level associated with a transform coefficient, the method includes adjusting the quantized data values to within the quantization level associated with the transform coefficient.

Block 450 provides for reapplying the artifact reduction process and readjusting the adjusted quantized data values. The reapplying the artifact reduction process can be part of a control process wherein restoration of the block of data occurs iteratively as shown in block 250 of FIG. 2. The reapplying can include converging on optimal quantized data values that converge on a probability distribution function associated with a source of the block of data.

Block 460 provides for optimizing each of the adjusted quantized data values as a function of one or more adjusted quantization values in an associated quantization level according to a measurement of error. For example, the optimizing can be in accordance with optimizer process 260 to adjust each DCT coefficient to a value that approaches a target statistic.

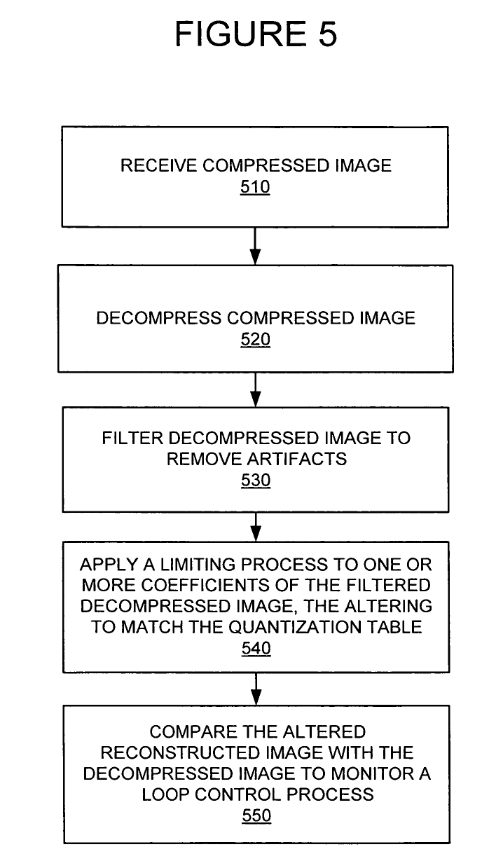

Referring now to FIG. 5, a flow diagram illustrates a method for restoring image data. More particularly, block 510 provides for receiving a compressed image. Block 520 provides for decompressing the compressed image, the decompressing including applying a quantization table. Block 530 provides for filtering the decompressed image to remove artifacts from the image data.

Block 540 provides applying a limiting process to one or more coefficients of the filtered decompressed image, the limiting process altering the one or more coefficients to match the quantization table to enable construction of an altered reconstructed image.

Block 550 provides for comparing the altered reconstructed image with the decompressed image to monitor a loop control process. The loop control process includes the limiting process, and the filtering and an optimization process, the optimization process altering the altered one or more coefficients to within a predetermined statistical range.

The control process iteratively adjusts the image reconstruction using statistics calculated from the image. Using the “a priori” assumption of the statistics for real images, the method will drive the adjustments towards target criteria. The method adjusts the reconstructed image to increase gradient of the image's probability distribution function. As the PDF is altered according to the process, the reconstructed image statistics become more uniform as compared to the quantized original image. The method may also employ target statistics such as the Mean Squared Error (MSE) or RMS Noise.

It will be apparent to those skilled in the art that many other alternate embodiments of the present invention are possible without departing from its broader spirit and scope. Moreover, in other embodiments the methods and systems presented can be applied to other types of signal than signals associated with camera images, comprising, for example, medical signals and video signals.

While the subject matter of the application has been shown and described with reference to particular embodiments thereof, it will be understood by those skilled in the art that the foregoing and other changes in form and detail may be made therein without departing from the spirit and scope of the subject matter of the application, including but not limited to additional, less or modified elements and/or additional, less or modified steps performed in the same or a different order.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

1. A method for removing artifacts for restoring one or more data blocks, the method comprising:
receiving one or more quantized transform coefficients of the one or more data blocks quantized according to a quantization table, the quantization table identifying two or more quantization levels;
reducing one or more artifacts via an artifact reduction process from the quantized transform coefficients, the artifact reduction process resulting in one or more processed transform coefficients; and
redistributing the processed transform coefficients in a transform domain to provide that the processed transform coefficients relate to the quantization table by:
maintaining a relative magnitude with respect to the order of the quantized transform coefficients; and
insuring the processed transform coefficients are located in the same two or more quantization levels as quantized according to the quantization table.

2. The method of claim 1 further comprising:
redistributing the rearranged processed transform coefficients across the quantization levels according to one or more predetermined criteria.

3. The method of claim 1 further comprising:
repeating the applying the artifact reduction process and the reducing until a distribution of the rearranged processed transform coefficients across the quantization levels one or more predetermined criteria.

4. The method of claim 3 wherein the predetermined criteria include one or more of a uniform distribution, a distribution altered by a scalar, and/or a distribution matching a predicted probability distribution function of the one or more data blocks.

5. The method of claim 1 wherein the processing the reduced artifact quantized transform coefficients includes:
determining a probability distribution function of a quantization level for each processed quantized transform coefficient; and
altering the magnitude of one or more of the processed quantized transform coefficients according to the probability distribution function for the quantization level.

6. The method of claim 1 further comprising:
determining an entropy for the one or more data blocks prior to reducing the artifacts via the artifact reduction process;
comparing a first entropy of the one or more data blocks prior to reducing the artifacts via the artifact reduction process with a second entropy of the one or more data blocks after the rearranging the one or more processed transform coefficients;
if the second entropy is lower than the first entropy, increasing the second entropy as a function of one or more of a probability distribution function, a uniform distribution function, a scalar value and/or a most likely (ML) algorithm.

7. A method for removing artifacts for restoring a block of data, the method comprising:
receiving one or more original transform coefficients of the block of data;
quantizing the original transform coefficients of the block of data, the quantizing resulting in one or more quantization levels associated with the one or more original transform coefficients;
applying an artifact reduction process to the quantized original transform coefficients;
adjusting one or more quantized data values representing the transform coefficients as altered by the artifact reduction process if any of the one or more quantized data values are outside the one or more quantization levels after applying the artifact reduction process; and
reapplying the artifact reduction process and readjusting the adjusted quantized data values, the reapplying the artifact reduction process enabling restoration of the block of data.

8. The method of claim 7 further comprising:
optimizing each of the adjusted quantized data values as a function of one or more adjusted quantization values in an associated quantization level according to a measurement of error.

9. The method of claim 2 wherein the measurement of error is a mean squared error and/or a measurement of the quantization level entropy as compared to an estimate of entropy representing a total of the one or more quantized transform coefficients of the block of data.

10. The method of claim 7 wherein the receiving one or more original transform coefficients of the block of data are one or more of discrete cosine transform coefficients, discrete Fourier transform coefficients, wavelet transform coefficients, and fractal transform coefficients.

11. The method of claim 7 wherein the quantizing the original transform coefficients of the block of data, the quantizing resulting in one or more quantization levels associated with the one or more original transform coefficients includes applying a uniform quantization process.

12. The method of claim 7 wherein the adjusting one or more quantized data values representing the transform coefficients as altered by the artifact reduction process if any of the one or more quantized data values are outside the one or more quantization levels after applying the artifact reduction process includes one or more of:
determining a transform coefficient associated with one or more of the quantized data values;
determining a quantization level associated with the transform coefficient;
if the quantized data values fall outside the quantization level associated with transform coefficient, adjusting the quantized data values to within the quantization level associated with the transform coefficient.

13. The method of claim 7 wherein the artifact reduction process uses high precision floating point numbers.

14. The method of claim 7 wherein the reapplying the artifact reduction process and readjusting the adjusted quantized data values, the reapplying the artifact reduction process enabling restoration of the block of data includes:
converging on optimal quantized data values that converge on a probability distribution function associated with a source of the block of data.

15. The method of claim 14 wherein the original block of data is a compressed JPEG file of an image and a probability distribution function associated with the source of the block of data is a Laplacian distribution function.

16. The method of claim 14 wherein the original block of data is a compressed JPEG file of an image and a probability distribution function associated with the quantized data is a Gaussian distribution function.

17. A method for restoring image data, the method comprising:
receiving a compressed image;
decompressing the compressed image, the decompressing including applying a quantization table;
filtering the decompressed image;
applying a limiting process to one or more coefficients of the filtered decompressed image, the limiting process altering the one or more coefficients to match the quantization table to enable construction of an altered reconstructed image; and
comparing the altered reconstructed image with the decompressed image to monitor a loop control process.

18. The method of claim 17 wherein the loop control process includes the limiting process, and the filtering and an optimization process, the optimization process altering the altered one or more coefficients to within a predetermined statistical range.

19. The method of claim 17 wherein filtering includes applying an artifact reduction process.

20. A computer system comprising:
a processor;
a memory coupled to the processor;
an image processing module coupled to the memory, the image processing module including:
a decompressor configured to receive a compressed image and decompress the compressed image with a quantization table;
a filter coupled to the decompressor, the filter configured to remove artifacts from the decompressed image via a smoothing function;
a limiter coupled to the filter, the limiter processing the one or more coefficients of the filtered decompressed image, the limiter altering the one or more coefficients to match the quantization table;
a control loop coupled to the limiter, the control loop configured to alter one or more components of the reconstructed image with the decompressed image to monitor a loop control process.

21. A computer program product comprising a computer readable medium configured to perform one or more acts for restoring one or more blocks of data, the one or more acts comprising:
receiving one or more original transform coefficients of the one or more blocks of data;
quantizing the original transform coefficients of the one or more blocks of data, the quantizing resulting in one or more quantization levels associated with the one or more original transform coefficients;
applying an artifact reduction process to the quantized original transform coefficients;
adjusting one or more quantized data values representing the transform coefficients as altered by the artifact reduction process if any of the one or more quantized data values are outside the one or more quantization levels after applying the artifact reduction process; and
reapplying the artifact reduction process and readjusting the adjusted quantized data values, the reapplying the artifact reduction process enabling restoration of the block of data.

22. The computer program product of claim 21 further comprising:
optimizing each of the adjusted quantized data values as a function of one or more adjusted quantization values in an associated quantization level according to a measurement of error.

23. The computer program product of claim 16 wherein the measurement of error is a mean squared error and/or a measurement of the quantization level entropy as compared to an estimate of entropy of a source of the block of data.

24. The computer program product of claim 21 wherein the receiving one or more original transform coefficients of the block of data are one or more of discrete cosine transform coefficients, discrete Fourier transform coefficients, wavelet transform coefficients, and fractal transform coefficients.

25. The computer program product of claim 21 wherein the quantizing the original transform coefficients of the block of data, the quantizing resulting in one or more quantization levels associated with the one or more original transform coefficients includes a uniform quantization process.

26. The computer program product of claim 21 wherein the adjusting one or more quantized data values representing the transform coefficients as altered by the artifact reduction process if any of the one or more quantized data values are outside the one or more quantization levels after applying the artifact reduction process includes one or more of:
determining a transform coefficient associated with one or more of the quantized data values;
determining a quantization level associated with the transform coefficient;
if the quantized data values fall outside the quantization level associated with transform coefficient, adjusting the quantized data values to within the quantization level associated with the transform coefficient.

27. The computer program product of claim 21 wherein the artifact reduction process uses high precision floating point numbers.

28. The computer program product of claim 21 wherein the reapplying the artifact reduction process and readjusting the adjusted quantized data values, the reapplying the artifact reduction process enabling restoration of the block of data includes:
converging on optimal quantized data values that converge on a probability distribution function associated with a source of the block of data.

29. The computer program product of claim 21 wherein the original block of data is a compressed JPEG file of an image and a probability distribution function associated with the source of the block of data is a Laplacian distribution function.

30. The computer program product of claim 21 wherein the original block of data is a compressed JPEG file of an image and a probability distribution function associated with the quantized data is a Gaussian distribution function.

31. A computer program product comprising a computer readable medium configured to perform one or more acts for removing artifacts for restoring one or more data blocks of data, the one or more acts comprising:
receiving one or more quantized transform coefficients of the one or more data blocks quantized according to a quantization table, the quantization table identifying two or more quantization levels;
reducing one or more artifacts via an artifact reduction process from the quantized transform coefficients, the artifact reduction process resulting in one or more processed transform coefficients; and
redistributing the processed transform coefficients in a transform domain to provide that the processed transform coefficients relate to the quantization table by:
maintaining a relative magnitude with respect to the order of the quantized transform coefficients; and
insuring the processed transform coefficients are located in the same two or more quantization levels as quantized according to the quantization table.
